(19) United States
(12) Patent Application Publication
(10) Pub. No.: US 2011/0088529 A1
(43) Pub. Date: Apr. 21, 2011

(54) HAND HOLE INSPECTION PLUG REMOVAL MACHINE

(76) Inventor: Charles E. Stuckey, York, SC (US)

(21) Appl. No.: 12/907,477

(22) Filed: Oct. 19, 2010

Related U.S. Application Data
(60) Provisional application No. 61/253,216, filed on Oct. 20, 2009.

(51) Int. Cl. B26D 5/00

(52) U.S. Cl. 83/821

(57) ABSTRACT

The instant invention is a hand hole inspection plug removal machine that includes a base plate, an alignment tool, and a head assembly. The base plate has a cutting hole and may be adapted to mount to a round object through a pair of rails attached to the bottom of the base plate on opposite sides. The alignment plug is adapted to align the center of the cutting hole with the center of a pre-drilled hole in the round object. The head assembly may be attached to the base plate and may be adapted to position a cutting tool over the center of the cutting hole and move the cutting tool up and down along the center line of the cutting hole. The head assembly includes a motor for spinning the cutting tool.

### RELATED APPLICATION

This application claims the benefit of co-pending U.S. provisional patent application Ser. No. 61/253,216 filed Oct. 20, 2009.

### FIELD OF THE INVENTION

The present invention is directed to a hand hole inspection plug removal machine for removing hand hole inspection plugs from waterwall tube headers of steam turbines in power plants.

### BACKGROUND OF THE INVENTION

A steam turbine is a mechanical device that extracts thermal energy from pressurized steam, and converts it into rotary motion. Steam turbines have almost completely replaced the reciprocating piston steam engine primarily because of its greater thermal efficiency and higher power-to-weight ratio. Because the turbine generates rotary motion, it is particularly suited to be used to drive an electrical generator and, as a result, provides for about 80% of all electricity generation in the world. The steam turbine is a form of heat engine that derives much of its improvement in thermodynamic efficiency through the use of multiple stages in the expansion of the steam, which results in a closer approach to the ideal reversible process.

In electrical power plants around the US and throughout the world, steam turbines require regular maintenance in order to maintain the safety and efficiency of the turbine and power plant. Usually maintenance is performed two times a year during the low electrical use times, like the spring and fall in the US, where less power is required to heat and cool.

During these down times where maintenance can be performed, one maintenance task that is typically performed is the inspection of the waterwall tube headers. Waterwall tube headers are a plurality of tubes used to move the pressurized steam to the turbine. The inspection of these waterwall tube headers is done by removing a plurality of pre-installed Hand Hole Inspection Plugs, whereby one can physically inspect the inside of the waterwall tube headers. The hand hole inspection plugs are typically removed by centering an air carbon arc gouging machine, or a similar device, to the inspection plug and arc gouging the fillet weld around the plug that fuses the plug to the pre-drilled holes of the waterwall tube headers. Once the inspection has occurred, the hand hole inspection plugs are fillet welded back into the holes.

One problem with this maintenance task is that arc gouging is not very precise. The arc gouging of the fillet weld holding the inspection plug into the hole in the waterwall tube headers typically leads to removal of some of the material of the header around the pre-drilled hole and/or some of the hand hole inspection plug. Thereafter, the shape of the hole and/or the shape of the hand hole inspection plug change each time the plugs are removed. Consequently, when the plug is re-welded back into the hole, the center of the plug is typically not centered with the hole. The next time the plug is removed by centering the arc gouging tool with the plug, even more material from the tube header and/or plug are removed. This problem is further exacerbated each time the hand hole inspection plugs are removed. This leads to the deterioration of the hand hole inspection plugs and/or the pre-drilled holes in the waterwall tube headers. As a result, a weaker seal between the hand hole inspection plug and the hole in the waterwall tube header is created each time the plugs are removed and re-installed. This often requires the hand hole inspection plugs to be replaced and the holes in the waterwall tube headers to be repaired.

Thus, there is a need for a device and method for a more efficient removal of the hand hole inspection plugs from waterwall tube headers in steam turbines used in power plants.

The instant invention is designed to address the above mentioned problems.

### SUMMARY OF THE INVENTION

The instant invention is a hand hole inspection plug removal machine. The hand hole inspection plug removal machine includes a base plate, an alignment tool, and a head assembly. The base plate has a cutting hole and may be adapted to mount to a round object through a pair of rails attached to the bottom of the base plate on opposite sides. The alignment plug is adapted to align the center of the cutting hole with the center of a pre-drilled hole in the round object. The head assembly may be attached to the base plate and may be adapted to position a cutting tool over the center of the cutting hole and move the cutting tool up and down along the center line of the cutting hole. The head assembly includes a motor for spinning the cutting tool.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a perspective environmental view of one embodiment of a hand hole inspection plug removal machine, according to the instant invention, mounted to a waterwall tube header. A second base plate according to the instant invention is also mounted to the waterwall tube header.

FIG. 2 is a perspective view of the hand hole inspection plug removal machine from claim 1.

FIG. 3 is another perspective view of the hand hole inspection plug removal machine from claim 1.

FIG. 4 is a side view of the hand hole inspection plug removal machine from claim 1.

FIG. 5 is a side view of the hand hole inspection plug removal machine from claim 1 showing the rotation of the machine about its hinge.

FIG. 6 is a side view of the hand hole inspection plug removal machine from claim 1 with the machine rotated 90 degrees away from its base plate about its hinge.

FIG. 7 is another environmental prospective view of the hand hole inspection plug removal machine from claim 1 showing the cutting tool.

FIG. 8 is a perspective view of one embodiment of the alignment tool made according to the instant invention.

FIG. 9 is a perspective view of the alignment tool shown in FIG. 8 installed on one embodiment of a base plate of the hand hole inspection plug machine of the instant invention.

### DETAILED DESCRIPTION OF THE INVENTION

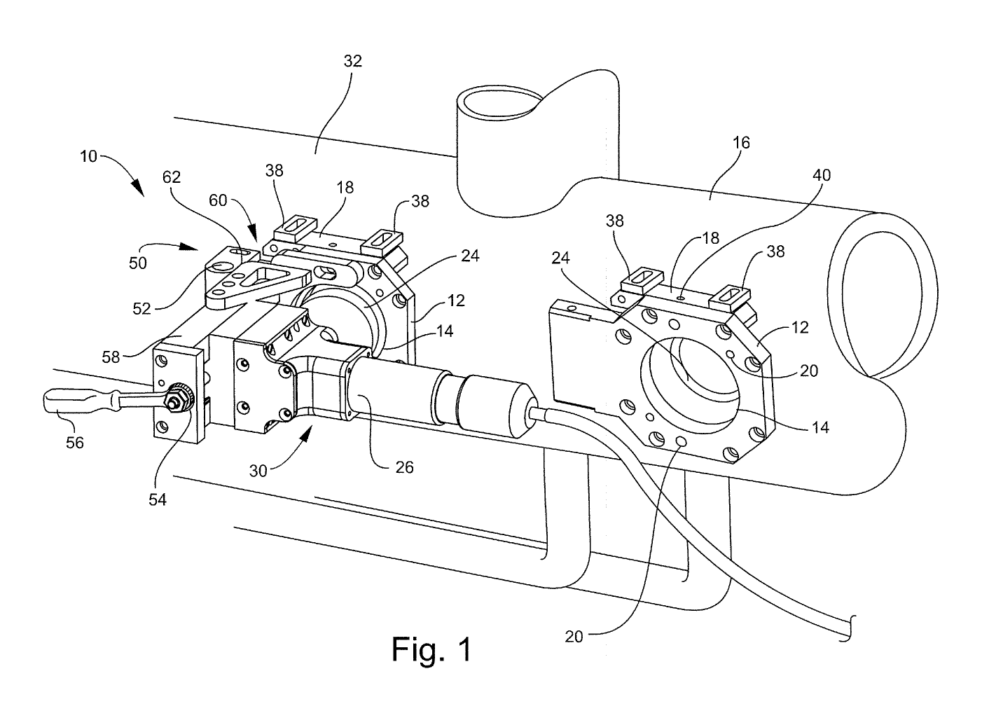

Referring to the drawings wherein like numerals refer to like elements, there is shown in FIG. 1 an embodiment of a hand hole inspection plug removal machine 10. Hand hole inspection plug removal machine 10 may be for removing hand hole inspection plugs from waterwall tube headers from steam turbines in power plants. Hand hole inspection plug removal machine 10 may remove hand hole inspection plugs more efficiently than the prior art machines. Previous machines were centered to the hand hole inspection plugs and the plugs were cut loose by arc gouging. On the other hand, the instant invention of machine 10 is designed to be center to the pre-drilled hole 24 in the waterwall tube header 32 (versus the plug) and uses a cutting tool 14 (versus arc gouging) to remove the hand hole inspection plug. The cutting tool 14 being centered to the pre-drilled hole 24 provides a clean cut around the hand hole inspection plug, which leaves a clean plug and a clean hole. This allows for the hand hole inspection plug to last longer and the weld/seal between the hole and the plug to be stronger each time the plugs are removed and reinstalled. Although hand hole inspection plug removal machine 10 is designed to remove hand hole inspection plugs from waterwall tube headers, the invention is not so limited and may be used for other purposes, as one skilled in the art should readily understand. The hand hole inspection plug removal machine 10 generally includes a base plate 12 and a head assembly 30.

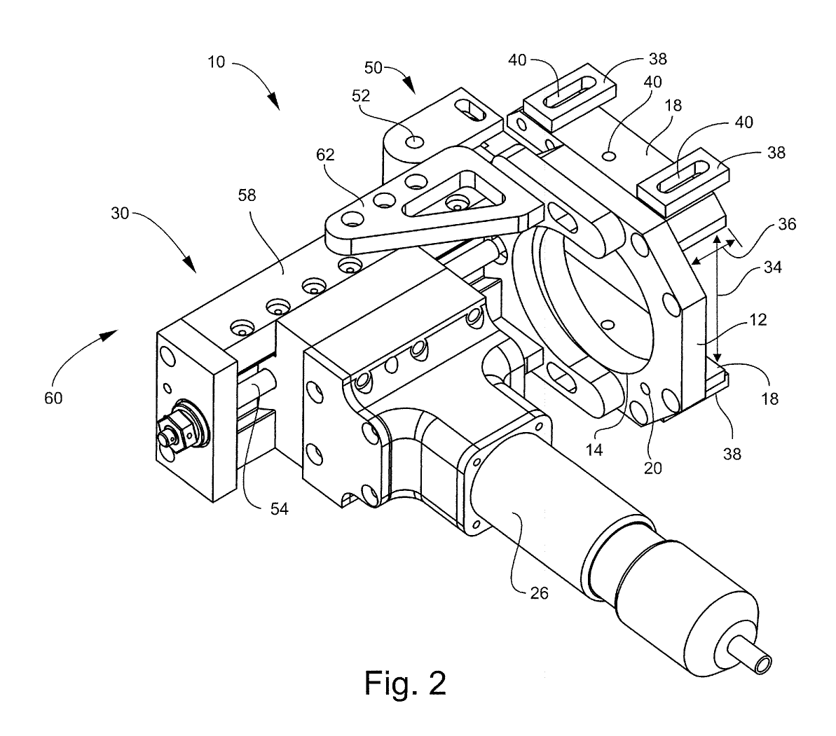

Base plate 12 may be included in hand hole inspection plug removal machine 10. See FIGS. 1-7 and 9. Base plate 12 may be for mounting machine 10 to an object 16. Base plate 12 may be adapted to mount to any size or shape object. In one embodiment, base plate 12 may be adapted to mount to a round object 16, like a waterwall tube header 32. Base plate 12 may be mounted to object 16 by any means, including, but not limited to, being welded to object 16, or being strapped or chained to object 16.

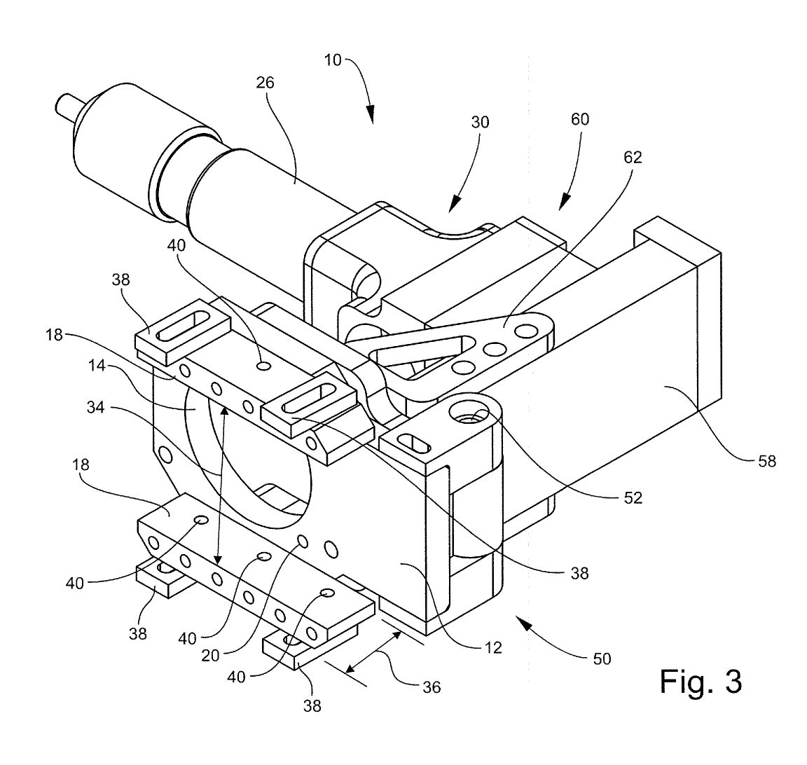

Base plate 12 may include a pair of rails 18. See FIG. 3. Pair of rails 18 may be for providing a pair of surfaces to mount machine 10 to round object 16. Rails 18 may have a height 26 and a spacing 34 between each rail. The height 26 and spacing 34 of rails 18, alone or in combination, may be sized depending on the radius of object 16. The height 26 and/or spacing 34 of rails 18 may provide two contact surfaces for base plate 12, thereby providing a stable position on round object 16. Rails 18 may prevent the bottom of base plate 12 from contacting round object 16. The greater the radius of object 16 allows for a greater spacing 34 and/or lower height 26. Vice versa, the lower the radius of object 16, allows for a smaller spacing 34 and/or greater height 26.

A plurality of mounting holes 40 may be provided in pair of rails 18. See FIGS. 1-4. Mounting holes 40 may be utilized for mounting base plate 12 to object 16. Rails 18 may include any number of mounting holes 40, including, but not limited to, three mounting holes 40, as shown in the Figures. However, the invention is not so limited and any number of mounting holes 40 may be provided in pair of rails 18. In one embodiment, mounting holes 40 may be utilized by connecting a plurality of weld tabs 38 to one or more mounting holes 40. Weld tabs 38 may then be mounted to object 16 by welding the welding tabs 38 to object 16. In one embodiment, four weld tabs 38 may be attached to side rails 18 via mounting holes 40. Weld tabs 38 may be disposable or replaceable and, thus, may prevent any permanent part of machine 10 or base plate 12 from being welded to the object. In another embodiment, mounting holes 40 may be utilized to connect a strap or chain around object 16 to secure base plate 12 to object 16. For example, the strap may include a come-a-long strap connected to the center of each rail through mounting holes 40 via a pair of eye bolts. As one skilled in the art should understand, mounting holes 40 may be utilized in numerous different ways for mounting machine 10 to object 16, like weld tabs, straps, chains, other like mounting devices, or combinations thereof.

Base plate 12 may include a cutting hole 14. See FIGS. 1-3 and 7. Cutting hole 14 may be for allowing cutting tool 28 to be lowered through base plate 12 and onto object 16. Cutting hole 14 may be any shape or size, including, but not limited to a circular hole. In one embodiment cutting hole 14 may be a circular hole with a diameter of 4 inches. Cutting hole 14 may also be used for centering base plate 12 to a pre-drilled hole 24 in object 16. As will be discussed below, alignment tool 22 may be utilized to center cutting hole 14 with pre-drilled hole 24.

Base plate 12 may also include an alignment hole 20 or a plurality of alignment holes 20. See FIGS. 1-3 and 7. Alignment holes 20 may be for connecting an alignment tool 22 to base plate 12. Alignment holes 20 may be positioned anywhere on base plate 12. In one embodiment, two alignment holes 20 may be provided on base plate 12 on opposite sides of cutting hole 14 along the center line of cutting hole 14. In this embodiment, alignment holes 20 may be two ⅜-16 holes adapted for allowing said alignment plug to be mounted to said base plate.

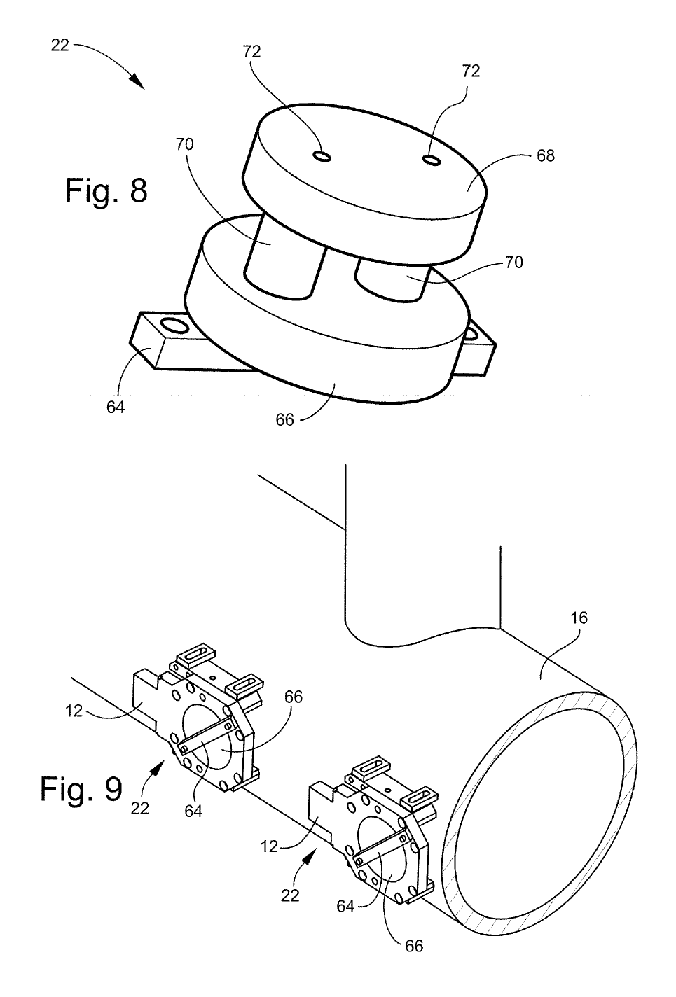

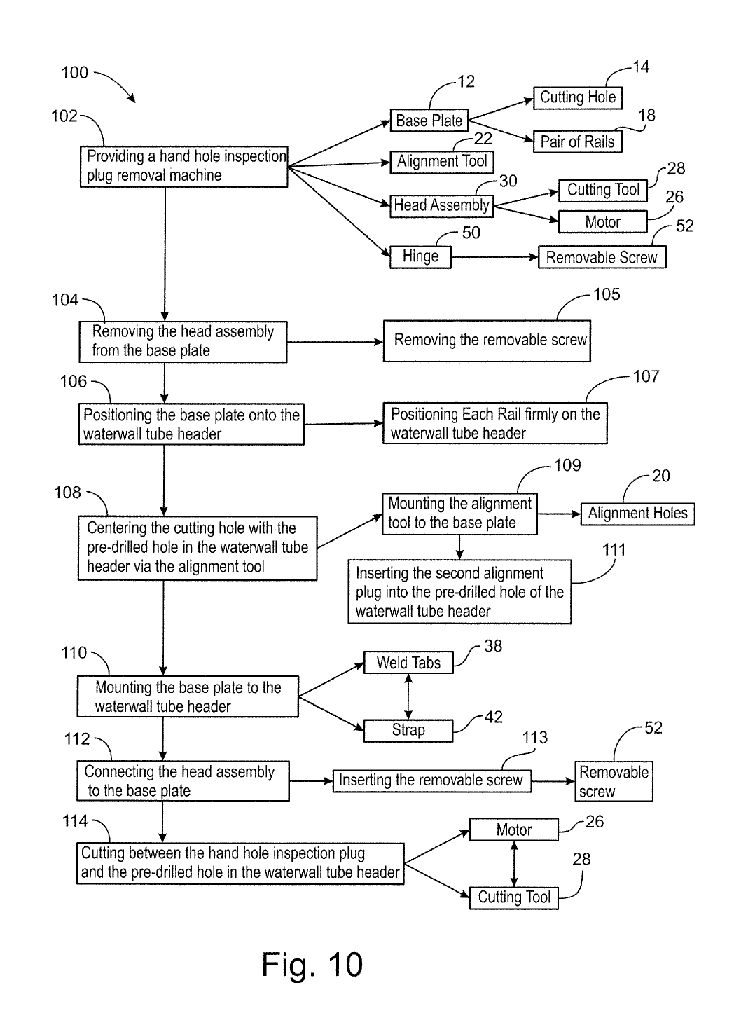

An alignment tool 22 may be included with base plate 12. See FIGS. 8-9. Alignment tool 22 may be for aligning cutting hole 14 with the center of pre-drilled hole 24 in object 16. Alignment tool 22 may be any device for aligning cutting hole 14 with the center of pre-drilled hole 24. For example, alignment tool 22 may align cutting hole 14 with the center of pre-drilled hole 24 for a hand hole inspection plug of a waterwall tube header from a steam turbine in a power plant. When alignment tool 22 may be mounted to base plate 12, alignment tool 22 may be inserted into pre-drilled hole 24 to align cutting hole 14 with pre-drilled hole 24. In one embodiment, alignment tool 22 may include a tool mount 64, a first plug 66, and a second plug 68. See FIG. 8.

Tool mount 64 may be included with alignment tool 22. See FIGS. 8-9. Tool mount 64 may be for mounting alignment tool 22 to base plate 12. Tool mount 64 may be any device for mounting alignment tool 22 to base plate 12. In one embodiment, tool mount 64 may be a bar having two tool holes 65 approximate each of its ends. Tool holes 65 may be adapted to align with alignment holes 20 on base plate 12 where alignment tool 22 is centered in cutting hole 14. In one embodiment, tool mount 64 may have two mounting holes 65 adapted to align with two alignment holes 20 when first alignment plug 66 is inserted into cutting hole 14. Tool mount 64 may also have holes for connecting to first plug 66 and second plug 68 via bolts 72.

First alignment plug 66 may be included in alignment tool 22. See FIGS. 8-9. First alignment plug 66 may be for centering alignment tool 22 within cutting hole 14. First alignment plug 66 may be adapted to fit within cutting hole 14. First alignment plug 66 may have any radius, including, but not limited to a radius of 2 inches. In one embodiment, first alignment plug 66 may be a circular disc sized slightly smaller than cutting hole 14, i.e., the size of first alignment plug 66 may be determined by the size of cutting hole 14. First alignment plug 66 may be secured to tool mount 64 by any means, including, but not limited to, by a plurality of bolts 72. In one embodiment, first alignment plug 66 may include two holes adapted to be secured to tool mount 64 by two bolts 72.

Second alignment plug 68 may be included in alignment tool 22. See FIGS. 8-9. Second alignment plug 68 may be for centering alignment tool 22 within pre-drilled hole 24 of object 16. Second alignment plug 68 may be adapted to fit within pre-drilled hole 24, like a pre-drilled hole for a hand hole inspection plug. For example, for a pre-drilled hole having a diameter of 3.375 inches, second alignment plug 68 may have a diameter of approximately 3.375 inches. In one embodiment, second alignment plug 68 may be a circular disc sized slightly smaller than pre-drilled hole 24, i.e., the size of second alignment plug 68 may be determined by the size of pre-drilled hole 24. Second alignment plug 68 may be secured to first alignment plug 66 by any means, including, but not limited to, by a plurality of bolts 72. In one embodiment, second alignment plug 68 may include two holes adapted to be secured to first alignment plug 68 by the same two bolts 72 that secure tool mount 64 to first alignment plug 66.

In one embodiment, alignment tool 22 may also include alignment plug spacers 70. See FIG. 8. Alignment plug spacers 70 may be for providing space between first alignment plug 66 and second alignment plug 68. The amount of space provided between the two alignment plugs may depend on a variety of factors, including, but not limited to, the height 36 and spacing 34 of rails 18, the radius of object 16, and the depth of pre-drilled hole 24. Typically, a hand hole inspection plug is recessed in the pre-drilled hole 24 approximately 1 inch. Thus, second alignment plug 68 may be inserted into pre-drilled hole 24 up to 1 inch. Spacers 70 may be sized accordingly.

Head assembly 30 may be included in hand hole inspection plug removal machine 10. See FIGS. 1-4 and 7. Head assembly 30 may be for housing cutting tool 28 and motor 26 of machine 10. Head assembly 30 may be any device for housing cutting tool 28 and motor 26. In one embodiment, head assembly 30 may include a vertical arm 58 attached to base plate 12. Vertical arm 58 may be supported by a pair of triangular support brackets 62 on both sides. Triangular support brackets 62 on each side of vertical arm 58 may be adapted to support vertical arm 58 in a perpendicular position relative to base plate 12. Head assembly 30 may position cutting tool 28 over the center of cutting hole 14. In addition, head assembly 30 may move cutting tool 28 up and down along the center line of cutting hole 14. In one embodiment, head assembly 30 may include a lead screw 54 positioned along vertical arm 58 adapted to move cutting tool 38 perpendicular to base plate 12 along vertical arm 58. Lead screw 54 may move cutting tool 38 perpendicular to base plate 12 by any means, including manual or automatic means. In one embodiment, a handle 56 may be connected to lead screw 54 adapted to allow a user to manually rotate lead screw 56, thereby moving the cutting tool up and down perpendicular to base plate 12. Handle 56 may be any type of handle, including a permanent handle attached to lead screw 54, or a simple torque wrench or socket removably attached to lead screw 54, as shown in FIG. 1. Motor 26 and cutting tool 28 may form a cutting assembly 60. Cutting assembly 60 may be slidably mounted to vertical arm 58 where lead screw 54 may be adapted to slide cutting assembly 60 up and down vertical arm 58. Cutting assembly 60 may be attached to vertical arm 58 by a bracket with a dove-tail joint configuration that allows the cutting assembly 60 to be perpendicularly fixed to vertical arm 58 while allowing cutting assembly 60 to move up and down vertical arm 58.

A motor 26 may be included in head assembly 30 of hand hole inspection plug removal machine 10. See FIGS. 1-4 and 7. Motor 26 may be for providing power to spin cutting tool 28. Motor 26 may be any device capable of providing power to spin cutting tool 28. Motor 26 may be any type of motor, including, but not limited to, an electric motor, a gas motor, a pneumatic motor, or other motors of the like. In one embodiment, motor 26 may be a pneumatic motor requiring a minimum of 90 psi/90 cfm. Motor 26 may include a standard drill chuck adapted to receive various cutting tools 28.

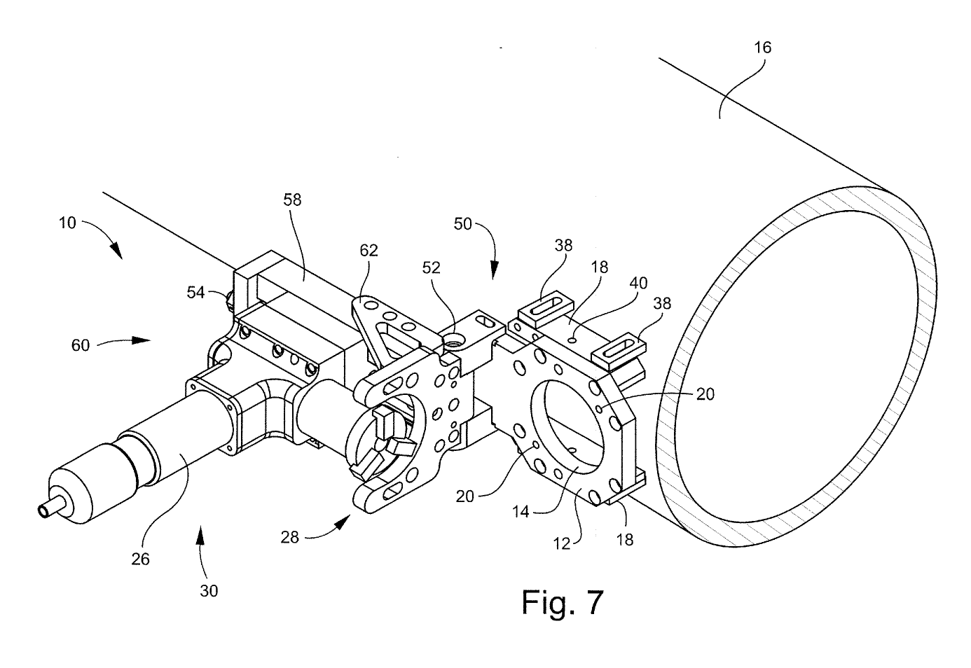

Cutting tool 28 may be included in head assembly 30 of hand hole inspection plug removal machine 10. See FIG. 7. Cutting tool 28 may be for cutting object 16. Cutting tool 28 may be any type of cutting tool adapted to fit in the chuck of motor 28, including, but not limited to, any standard drill bits, standard hole saws, high speed tools, and any other standard or custom tools. In one embodiment, the cutting tool may be a high speed steel tooling HIPRT-120. High speed steel tooling HIPRT-120 may be ideal for cutting the weld between hand hole inspection plugs and the pre-drilled holes 24 in water wall tube headers.

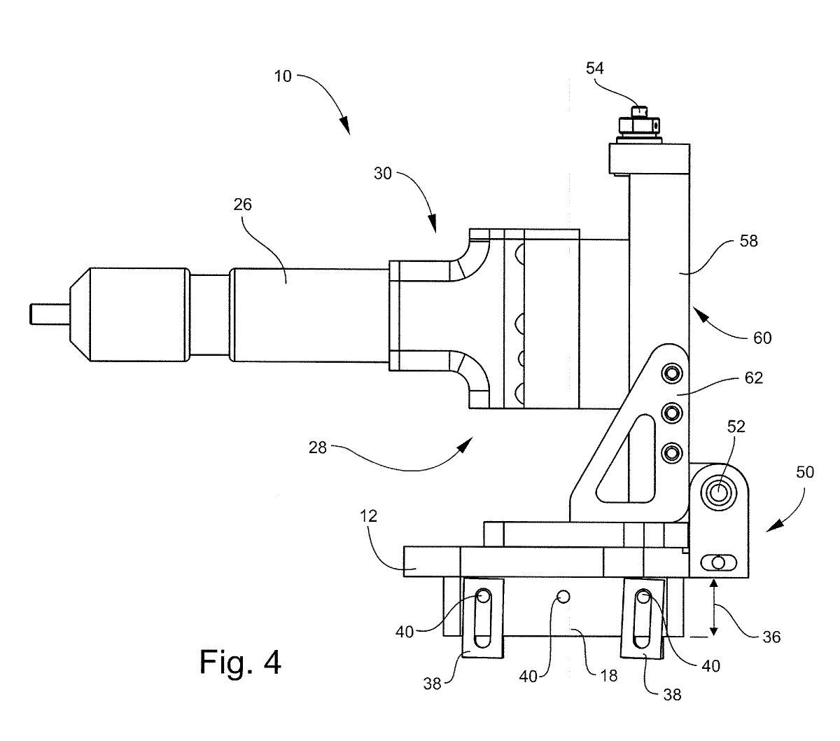

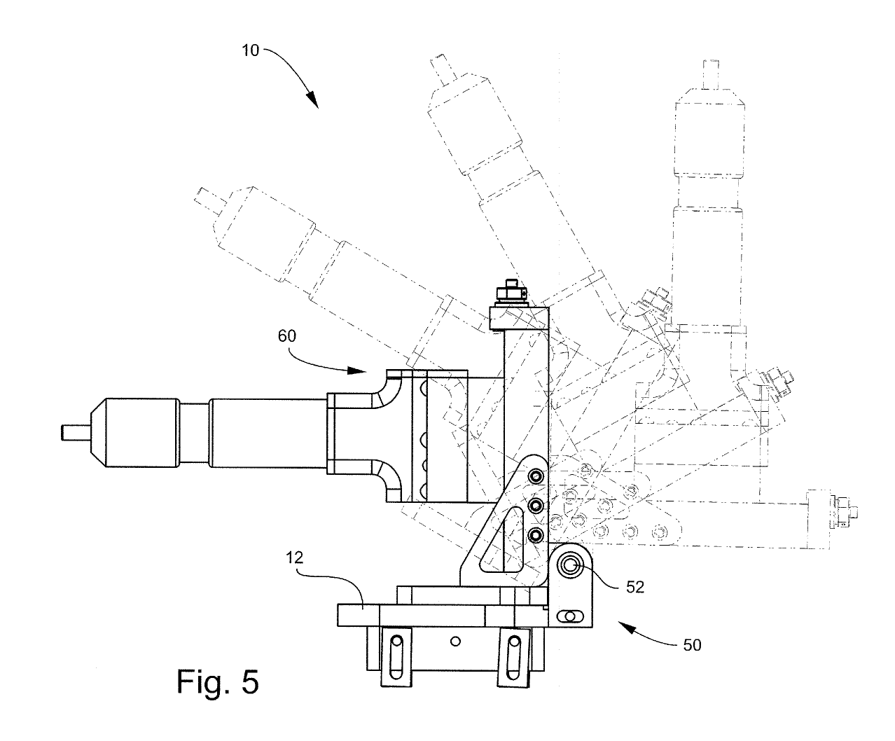

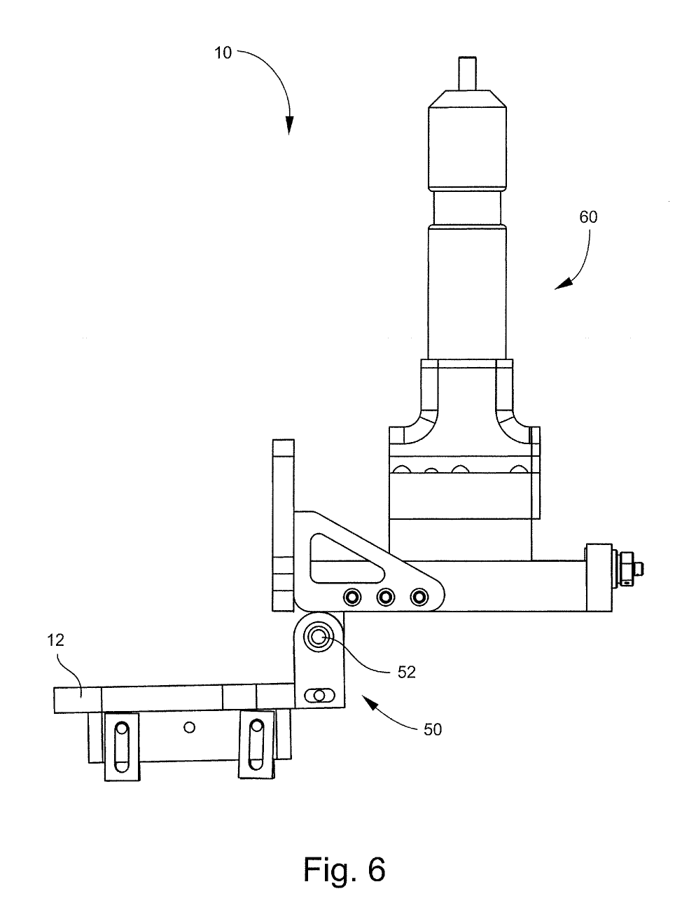

In one embodiment, head assembly 30 may be attached to base plate 12 via a hinge 50. See FIGS. 1-7. Hinge 50 may be for allowing head assembly 30 to rotate away from cutting hole 14 in base plate 12. See FIGS. 4-6. Hinge 50 may be any type, shape or size hinge that allows head assembly 30 to rotate away from base plate 12. FIG. 4 shows head assembly 30 positioned over base plate 12. FIG. 5 shows head assembly 30 rotating away from base plate 12. Finally, FIG. 6 shows head assembly 30 rotated 90 degrees from base plate 12. In one embodiment hinge 50 may include a removable screw 52 that connects base plate 12 to head assembly 30. Removable screw 52 may be removed from hinge 50 to allow head assembly 30 to be completely removed from base plate 12. Removing head assembly 30 from base plate 12 may allow base plate 12 to be mounted to object 16 more easily. In addition, providing hinge 50 with a removable screw 52 allows head assembly 30 to be attached to multiple base plates 12. Thus, multiple base plates 12 may be mounted to waterwall tube header 32, where the same head assembly 30 may be attached to each base plate 12 to remove multiple hand hole inspection plugs more efficiently, as depicted in FIGS. 1 and 9.

The instant invention of a hand hole inspection plug removal machine allows for a new method 100 of removing a hand hole inspection plug from a waterwall tube header. The method includes the following steps: a step 102 of providing a hand hole inspection plug removal machine having a base plate with an alignment tool and a head assembly mounted to said base plate via a hinge; a step 104 of removing the head assembly from the base plate; a step 106 of positioning the base plate onto the waterwall tube header; a step 108 of centering the cutting hole with a pre-drilled hole in the waterwall tube header with a hand hole inspection plug via the alignment tool; a step 110 of mounting the base plate to the waterwall tube header; a step 112 of connecting the head assembly to the base plate; and a step 114 of cutting between the hand hole inspection plug and the pre-drilled hole in the waterwall tube header.

Step 102 of providing a hand hole inspection plug removal machine may be included in method 100 of removing a hand hole inspection plug from a waterwall tube header. See FIG. 10. Step 102 may include providing a hand hole inspection plug removal machine 10, as described above according to the instant invention. This includes, but is not limited to, providing a hand hole inspection plug removal machine 10 including a base plate 12 with a cutting hole 14 and a pair of rails 18 mounted to the bottom of the base plate on opposite sides. Hand hole inspection plug removal machine 10 may also include multiple base plates 12. As shown in FIGS. 1 and 9, this may allow the multiple base plates 12 to be mounted to the waterwall tube header 32, or other round object 16, where the head assembly 30 may be connected to each base plate 12 via hinge 50.

Step 104 of removing head assembly 30 from base plate 12 may be included in method 100 of removing a hand hole inspection plug from a waterwall tube header. See FIG. 10. Step 104 may be for separating the base plate from the rest of the machine to allow the base plate to be mounted to the waterwall tube header 32, or other round object 16, more easily. Step 104 may include any steps for removing the head assembly 30 from base plate 12, including, but not limited to, a step 105 of removing the removable screw 52 from hinge 50.

Step 106 of positioning the base plate onto the waterwall tube header may be included in method 100 of removing a hand hole inspection plug from a waterwall tube header. See FIG. 10. Step 106 may include, but is not limited to, a step 107 of positioning each rail 18 firmly on the waterwall tube header 32, or other round object 16. This step may position base plate 12 in a stable position on waterwall tube header 32, where each rail 18 contacts the surface of waterwall tube header 32 and stabilizes the base plate.

Step 108 of centering the cutting hole 14 with the pre-drilled hole 24 of the waterwall tube header 32, or other round object 16, may be included in method 100 of removing a hand hole inspection plug from a waterwall tube header. See FIG. 10. Step 108 may include any steps for centering the cutting hole 14 with the pre-drilled hole 24. In one embodiment, step 108 may include a step 109 of mounting the alignment tool 22 to the base plate 12. Step 109 may include any steps for mounting the alignment tool 22 to the base plate 12, including inserting the first alignment plug 66 into the cutting hole 14 and attaching alignment tool mount 64 to base plate 12 via alignment holes 20. Step 108 may also include a step 111 of inserting the second alignment plug 68 into the pre-drilled hole 24 of the waterwall tube header 32, or other round object 16.

Step 110 of mounting the base plate 12 to the waterwall tube header 32, or other round object 16, may be included in method 100 of removing a hand hole inspection plug from a waterwall tube header. See FIG. 10. Step 110 may be for securing the base plate 12 to the waterwall tube header or other object and may include any steps for securing the base plate 12 to the object. For example, step 110 may include welding the welding tabs 38 to the object, securing a strap 42 or chain around the object, other like means, or a combination thereof.

Step 112 of connecting head assembly 30 to base plate 12 may be included in method 100 of removing a hand hole inspection plug from a waterwall tube header. See FIG. 10. Step 112 may be for attaching the head assembly 30 to one or more of the mounted base plates 12 on the waterwall tube header 32, or other round object 16. Step 112 may include any steps for attaching head assembly 30 to the one or more mounted base plates 12. In one embodiment, step 112 may include a step 113 of inserting removable screw 52 into hinge 50 for connecting the head assembly 30 to base plate 12.

Step 114 of cutting between the hand hole inspection plug and the pre-drilled hole in the waterwall tube header 32 may be included in method 100 of removing a hand hole inspection plug from a waterwall tube header. See FIG. 10. Step 114 may include any steps for cutting between the hand hole inspection plug and the pre-drilled hole in the waterwall tube header 32, or other object 16, including, but not limited to, selecting and connecting the proper cutting tool 28, powering motor 26, and rotating lead screw 54 to lower cutting tool 28 into pre-drilled hole 24. This step may cut loose the hand hole inspection plug from the pre-drilled hole and allow a user to remove the hand hole inspection plug.

After the hand hole inspection plug is removed, the inside of the waterwall tube header 32, or any other round object 16, may be inspected through pre-drilled hole 24. Once inspection is complete, the hand hole-inspection plug may be welded back into pre-drilled hole 24. Because, the hand hole-inspection plug was cut properly from the pre-drilled hole 24, the seal between the hand hole inspection plug and the pre-drilled hole 24 may be strong. In addition, there will be no need to repair/replace the hand hole inspection plug and/or repair the pre-drilled hole 24.

The present invention may be embodied in other forms without departing from the spirit and the essential attributes thereof, and, accordingly, reference should be made to the appended claims, rather than to the foregoing specification, as indicating the scope of the invention.

I claim:

1. A hand hole inspection plug removal machine comprising:
a base plate having a cutting hole and a pair of rails attached to the bottom of said base plate on opposite sides, said base plate being adapted to mount to a round object via said pair of rails;
an alignment tool being mountable to said base plate, where said alignment tool aligning the center of said cutting hole with the center of a pre-drilled hole in said round object; and
a head assembly attached to said base plate having a cutting tool positioned over the center of said cutting hole and being adapted to move said cutting tool up and down along the center line of said cutting hole;
said head assembly including a motor adapted to spin said cutting tool.

2. The hand hole inspection plug removal machine of claim 1 where said base plate being adapted to mount to a waterwall tube header where said pre-drilled hole being for a hand hole inspection plug, and said cutting tool being adapted to cut between said hand hole inspection plug and said pre-drilled hole.

3. The hand hole inspection plug removal machine of claim 1 where said pair of rails attached to the bottom of said base plate on opposite ends having a spacing and a height, said spacing and said height allowing each of said rails to contact said round object, thereby allowing said base plate to be positioned and mounted to said round object.

4. The hand hole inspection plug removal machine of claim 1 where said base plate including at least one alignment hole adapted for allowing said alignment tool to be mounted to said base plate.

5. The hand hole inspection plug removal machine of claim 4 where said alignment holes being two ⅜-16 holes adapted for allowing said alignment plug to be mounted to said base plate.

6. The hand hole inspection plug removal machine of claim 1 where said alignment tool comprising:
a tool mount adapted to mount said alignment tool to said base plate via said alignment hole;
a first alignment plug attached to said tool mount adapted to fit inside said cutting hole;
a second alignment plug attached to said first alignment plug adapted to fit inside said pre-drilled hole; and
alignment plug spacers between said first alignment plug and said second alignment plug;
whereby, when said alignment plug being mounted to said base plate, said second alignment plug may be inserted into said pre-drilled hole to align said cutting hole with said pre-drilled hole and said alignment plug spacers positioning said second alignment plug to be inserted approximately 1 inch into said pre-drilled hole.

7. The hand hole inspection plug removal machine of claim 6 where said base plate having two alignment holes on opposite sides of said cutting hole along the center line of said cutting hole, and said tool mount having two mounting holes adapted to align with said two alignment holes when said first alignment plug being inserted into said cutting hole.

8. The hand hole inspection plug removal machine of claim 1 where said base plate further comprising a plurality of weld tabs adapted to allow said base plate to be welded to said round object.

9. The hand hole inspection plug removal machine of claim 8 where said weld tabs being adapted to be attached to a plurality of mounting holes in said rails.

10. The hand hole inspection plug removal machine of claim 1 where said motor being selected from the group consisting of: an electric motor, a gas motor, and a pneumatic motor.

11. The hand hole inspection plug removal machine of claim 10 where said pneumatic motor requiring a minimum of 90 psi/90 cfm.

12. The hand hole inspection plug removal machine of claim 1 where said head assembly being attached to said base plate via a hinge, whereby, said cutting tool may be hinged away from said cutting hole.

13. The hand hole inspection plug removal machine of claim 12 where said hinge including a removable screw thereby allowing said head assembly to be removed from said base plate.

15. The hand hole inspection plug removal machine of claim 1 where said head assembly including a lead screw adapted to move said cutting tool perpendicular to said base plate.

16. The hand hole inspection plug removal machine of claim 16 where said lead screw including a handle adapted to allow a user to rotate said lead screw thereby moving said cutting tool up and down perpendicular to said base plate.

17. The hand hole inspection plug removal machine of claim 1 where said head assembly comprising:
a vertical arm including said lead screw being attached to said base plate via said hinge;
a cutting assembly including said motor and said cutting tool being slidably mounted to said vertical arm via a dove tail groove where said lead screw being adapted to slide said cutting assembly up and down said vertical arm; and
a pair of triangular support brackets on each side of said vertical arm adapted to hold said vertical arm in a perpendicular position relative to said base plate.

18. The hand hole inspection plug removal machine of claim 1 where said cutting tool being a high speed steel tooling HIPRT-120.

19. An alignment tool for a base plate of a hand hole inspection plug removal machine comprising:
a tool mount adapted to mount said alignment tool to a pair of alignment holes in said base plate via said alignment holes;
said base plate having two alignment holes on opposite sides of said cutting hole along the center line of said cutting hole, and said tool mount having two mounting holes adapted to align with said two alignment holes when a first alignment plug being inserted into said cutting hole;
said first alignment plug being attached to said tool mount and fitting inside a cutting hole in said base plate; and
a second alignment plug attached to said first alignment plug via a plurality of bolts, said second alignment plug fitting inside a pre-drilled hole in a round object;
a plurality of alignment plug spacers positioned between said first alignment plug said second alignment plug, where said plurality of bolts running through said alignment plug spacers;
whereby, when said alignment plug being mounted to said base plate, said second alignment plug may be inserted into said pre-drilled hole to align said cutting hole with said pre-drilled hole.

20. A method of removing a hand hole inspection plug from a waterwall tube header comprising the steps of:
providing a hand hole inspection plug removal machine having a base plate with an alignment tool and a head assembly mounted to said base plate via a hinge;
removing said head assembly from said base plate;
positioning said base plate onto said waterwall tube header;
centering said cutting hole with a pre-drilled hole in said waterwall tube header with a hand hole inspection plug via said alignment tool;
mounting said base plate to said waterwall tube header;
connecting said head assembly to said base plate; and
cutting between said hand hole inspection plug and said pre-drilled hole in said waterwall tube header.
